(19) United States
(12) Patent Application Publication
(10) Pub. No.: US 2022/0335451 A1
(43) Pub. Date: Oct. 20, 2022

(54) COMPUTER-BASED MONITORING OF DATA RECORDS OF LOGGED CONSUMER DATA

(71) Applicant: The Nielsen Company (US), LLC, New York, NY (US)

(72) Inventors: Leslie Wood, Copake Falls, NY (US); Amy Crooks, Jersey City, NJ (US); Andrew Faehnle, Cincinnati, OH (US); Brett Mershman, Wheaton, IL (US); Samuel Kirschner, Cincinnati, OH (US)

(21) Appl. No.: 17/723,198

(22) Filed: Apr. 18, 2022

Related U.S. Application Data
(60) Provisional application No. 63/177,255, filed on Apr. 20, 2021.

(51) Int. Cl. G06Q 30/02

(52) U.S. Cl. CPC G06Q 30/0201; G06Q 30/0203; G06Q 30/0255

(57) ABSTRACT

Disclosed examples determine a first level of loyalty to a brand for a household based on first data records of consumer data corresponding to a first period of time; determine a second level of loyalty to the brand for the household based on second data records of consumer data corresponding to a second period of time after the first time period; determine consumer metrics based on the first level of loyalty and the second level of loyalty; and generate a report based on the consumer metrics.

### RELATED APPLICATION

This patent claims the benefit of U.S. Provisional Patent Application No. 63/177,255, which was filed on Apr. 20, 2021. U.S. Provisional Patent Application No. 63/177,255 is hereby incorporated herein by reference in its entirety. Priority to U.S. Provisional Patent Application No. 63/177,255 is hereby claimed.

### FIELD OF THE DISCLOSURE

This disclosure relates generally to computer systems, and, more particularly, to computer-based monitoring of data records of logged consumer data.

### BACKGROUND

Companies rely on loyalty from their customers. For example, a company that sells a product (e.g., soda) may want to closely monitors how many customers are consistently purchasing their product, how many previously loyal customers are changing to other products, how many customers are not purchasing any products in their category of products (e.g., customers who do not purchase any soda), and how many new customers have become loyal to their company. Historically, brand loyalty has remained relatively constant. However, as the world changes, loyalty to brands has become less constant. For example, the Covid-19 pandemic has led to large shifts in brand loyalty due to brand availability, changes in consumer resources, changes in consumer mentality, changes in consumer lifestyle, etc.

### BRIEF DESCRIPTION OF THE DRAWINGS

FIG. 1 is an example environment described in conjunction with examples disclosed herein.

FIG. 2 is a block diagram of example consumer-product analysis circuitry.

FIGS. 3-4 illustrate flowcharts representative of machine readable instructions which may be executed to implement the example consumer-product analysis circuitry of FIG. 2.

FIGS. 5A-5G illustrate example reports that may be generated by the example consumer-product analysis circuitry of FIG. 2.

FIG. 6 is a block diagram of an example processing platform structured to execute the instructions of FIGS. 3 and 4 to implement the example consumer-product analysis circuitry of FIG. 2.

FIG. 7 is a block diagram of an example implementation of the processor circuitry of FIG. 6.

FIG. 8 is a block diagram of another example implementation of the processor circuitry of FIG. 6.

FIG. 9 is a block diagram of an example software distribution platform (e.g., one or more servers) to distribute software (e.g., software corresponding to the example machine readable instructions of FIGS. 3 and 4) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Computing systems are capable of obtaining consumer data related purchases, behaviors, and/or media exposures of people to be able to determine a loyalty to a brand. However, computing systems are not currently able to track changes in loyalty and/or monitor loyalty with respect to time. Examples disclosed herein program a computer to be able track brand loyalty across time based on a brand loyalty hierarchy that includes five levels or steps. The five levels include a loyal level (e.g., the highest level or level 5), a switcher level (e.g., level 4), a non-loyal level (e.g., level 3), a non-brand level (e.g., level 2), and a non-category level (e.g., the lowest level or level 1). A person, group of people, household, etc. is part of a loyal level when the amount of purchases of the person, group of people, household, etc. (e.g., purchase of brand dollars out of total category dollars, purchases of brand units out of total category units, purchases of brand volume out of total category volume, etc.) is more than a threshold percent (e.g., 70%, 80%, 90%, etc.) (e.g., when a consumer purchases soda, the consumer purchases “COKE®” more than a threshold percentage of the time) within a duration of time (e.g., a month, a year, etc.). A person, group of people, household, etc. is part of a switcher level when the person, group of people, household, etc. purchases of a particular item that corresponds to a brand are within a threshold percent range (e.g., less than the threshold percent of a loyal consumer but more than the threshold percent of a non-loyal level) or within a purchase quantity range. A person, group of people, household, etc. is part of a non-loyal level when the person, group of people, household, etc. purchases less than a threshold percentage (e.g., 30%, 20%, 10%, etc.) or quantity of a particular item that corresponds to a brand (e.g., when a consumer purchases soda, the consumer purchases “COKE®” more than a threshold percentage of the time), but more than zero within a duration of time (e.g., a month, a year, etc.). A person, group of people, household, etc. is part of a non-brand level when the person, group of people, household, etc. purchases items corresponding to the category of the brand (e.g., soda) but does not purchase the items of the brand (e.g., when the consumer purchases soda, but does not purchase “COKE®”). A person, group of people, household, etc. is part of a non-category level when the person, group of people, household, etc. does not purchase any items corresponding to the category of the brand (e.g., a consumer did not purchase any type of soda within a duration of time). Although examples disclosed herein divide loyalty into five steps or layers, any number of layers may be used.

To monitor loyalty, examples disclosed herein analyze consumer data (e.g., purchase data, exposure data, etc.) for one or more people, group(s) of people, household(s), etc. to determine a level of loyalty to a particular brand during a first time period. In some examples, consumer data could be replaced with exposure data (e.g., corresponding to loyalty of a particular show or stations verses other shows and/or stations within a category, time slot, day, week, etc.), website visits (e.g., corresponding to brand loyalty to a particular website (e.g., CNN.com) versus other websites in the same category (e.g., other news websites), store visits (e.g., corresponding to loyalty of a particular store versus other stores in the same category), etc. In some examples, the full set of households may be broken into one or more subsets of households. For example, a subset of households that were exposed to an advertisement and were responsive may be examined, monitored, and/or analyzed. After the first level is determined, examples disclosed herein analyze consumer data for the one or more people, group(s) of people, household(s) etc. to determine a second level of loyalty to a brand during a second time period after the first time period. Examples disclosed herein generate a report with metrics based on a comparison of the first level and the second level. The metrics may include data related to brand retention, churn, acquired consumers, lost consumers, acquisition data, attrition data, lapsed consumers, etc. As used herein, “churn” refers to a change from one layer of the loyalty hierarchy to another layer. As used herein, “retention” refers to a consumer corresponding to the same level of loyalty hierarchy from a first time to a second time. As used herein, “acquisition” refers to consumers (e.g., buyers) that increase in loyalty level (e.g., from non-brand consumer to a brand consumer) from the first time to the second time. As used herein, “attrition” refers to consumers that decrease in loyalty level (e.g., from brand consumers to non-brand consumers) from the first time to the second time.

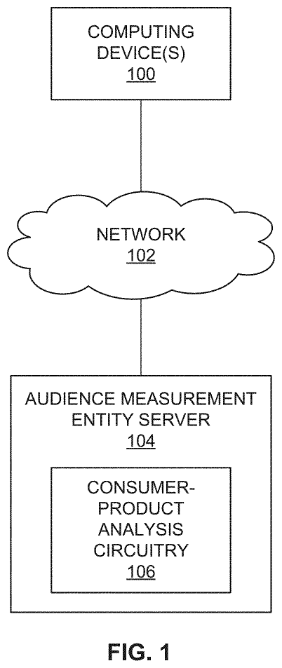

FIG. 1 is an example environment that includes an example computing device(s) 100, an example network 102, an example audience measurement entity server 104, and example consumer-product analysis circuitry 106.

The example computing device(s) 100 of FIG. 1 collect(s) logged consumer data associated with one or more consumers, groups of consumers, and/or households. The consumer data is related to purchases of items in a category that corresponds to a brand. For example, consumer data may include brands of beer that were purchased by households with a time and/or date of purchase, location of the purchase and/or household, demographics of the household, etc. The computing device(s) 100 may be a personal computing device(s) and/or a meter(s) that obtain(s) the consumer data from a panel of consumers or shopper (e.g., using a digital meter or personal people meter), from consumer responses to survey data (displayed on a user interface of the computing device(s) 100), from websites, etc. In some examples, the computing device(s) 100 may be in stores that sell the brand, may be servers of websites, may be operated by third-party database proprietors to log the consumer, may implement third-party monitors, and/or may be owned and/or operated by any other source of the logged consumer data. Additionally or alternatively, the computing device(s) 100 may collect any type of brand exposure data (e.g., when one or more consumer(s) was exposed to the brand on a website, television, etc.). The computing device(s) 100 transmit(s) the purchase and/or exposure data to the example audience measurement entity server 104 via the network 102.

The example network 102 of FIG. 1 is a system of interconnected systems to exchange data. The example network 102 may be implemented using any type of public and/or private network such as, but not limited to, the Internet, a telephone network, a local area network (LAN), a cable network, and/or a wireless network. To enable communication via the network 102, the example computing device(s) 100 and/or the audience measurement entity 104 includes communication circuitry (e.g., a communication interface and/or network interface) that enables a connection to an Ethernet, a digital subscriber line (DSL), a telephone line, a coaxial cable, or any wireless connection, etc. In some examples, the computing device(s) 100 and the example audience measurement entity server 104 are connected via the example network 102.

The example audience measurement entity server 104 of FIG. 1 is a trusted (e.g., neutral) third party (e.g., The Nielsen Company, LLC) for providing accurate media access (e.g., media exposure, media impression, etc.) statistics. The example AME server 104 monitors purchase information and/or exposure to media via the computing device(s) 100. In this manner, the example AME server 104 can determine purchase metrics corresponding to brand loyalty and/or exposure metrics for different media based on the collected purchase and/or media measurement data. The example audience measurement entity server includes the example consumer-product analysis circuitry 106, as further described below.

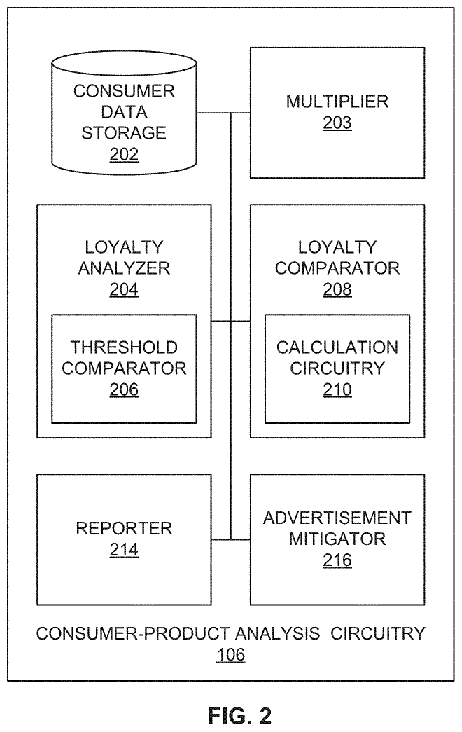

The example consumer-product analysis circuitry 106 of FIG. 1 analyzes loyalty of consumers to products, websites, media, etc. The example consumer-product analysis circuitry 106 analyzes consumer and/or consumption data (e.g., purchases and/or exposure related to products and/or media) to identify loyalty levels of consumers and/or groups of consumers and other various consumer/consumption metrics with respect to time (e.g., brand retention, churn, acquired consumers, lost consumers, acquisition data, attrition data, lapsed consumers, etc.). For example, the consumer-product analysis circuitry 106 can monitor one or more consumers to determine a churn per household, an average absolute steps per household, and/or a net brand churn per household based on loyalty data of households (e.g., all households or one or more subgroups of households, where a subgroup may correspond to households exposed to an advertisement or media, households that performed an action in response to exposure to an advertisement or media, one or more demographics of the households, locations of the households, etc.) between two durations based on household data between two periods, as further described below. The example consumer-product analysis circuitry 106 can generate a report based on the purchase and/or exposure metrics and/or perform loyalty-based mitigation to attempt to increase loyalty of a product or service. The example consumer-product analysis circuitry 106 is further described below in conjunction with FIG. 2.

FIG. 2 is a block diagram of the example consumer-product analysis circuitry 106 of FIG. 1. The example consumer-product analysis circuitry 106 includes an example consumer data storage 202, an example multiplier 203, an example loyalty analyzer 204, an example threshold comparator 206, an example loyalty comparator 208, an example calculation circuitry 210, an example calculation circuitry 210, an example reporter 214, and an example advertisement mitigator 216.

The example consumer data storage 202 of FIG. 2 stores records of logged consumer data corresponding to consumers, groups of consumers, and/or households. The consumer data is related to the purchases of items in a category that corresponds to a brand. For example, consumer data may include brands of beer that were purchased by households with a time and/or date of purchase, location of the purchase and/or household, demographics of the household, etc. The consumer data may be obtained from a panel, from survey data, from stores that sell the brand, from websites, from third-party database proprietors, from third-party monitors, and/or from any other source. Additionally or alternatively, the consumer data may be brand exposure data (e.g., when a consumer was exposed to the brand via media (e.g., an advertisement or content on a website, television, etc.).

The example multiplier 203 of FIG. 2 (e.g., also referred to as multiplication circuitry) weights the consumers, groups of consumers, and/or households so that the consumers, groups of consumers, and/or households more accurately represent a universe of consumers. For example, because the consumer data storage 202 may include only data representative of a portion of the universe of purchases, the consumer-product analysis circuitry 106 and/or another device may determine how to weight each individual consumers, groups of consumers, and/or households so that when the weights are applied to the respective consumers, groups of consumers, and/or households, the weighted consumer data more accurately represents the universe of purchases. The example multiplier 203 weights (e.g., by multiplying the weight) a household by the corresponding weight. In this manner, instead of data from the household being represented as one household, the data from the household may represent 1,500 households of the universe of consumers.

The example loyalty analyzer 204 of FIG. 2 (e.g., also referred to as loyalty analyzation circuitry) determines and/or labels each household (or individual consumer, groups of consumers, etc.) within a duration of time as one of the five levels in the loyalty hierarchy based on the purchases made by the household within the duration of time. For example, for a report that corresponds to loyalty to COKE® among soda brands, the loyalty analyzer 204 analyzes the purchase history of a household with a first duration of time (e.g., a year) to determine whether or not the household purchased soda and, if it did, what percentage of the purchases were for COKE® and what percentages were for other brands. If the example loyalty analyzer 204 determines that there were no items purchased by the household from the category (e.g., soda) corresponding to the brand of interest (e.g., COKE®), the example loyalty analyzer 204 labels the household as at the “non-category” level of the loyalty hierarchy. If the example loyalty analyzer 204 determines that the category of item corresponding to the brand was purchased with the duration of time, the example threshold comparator 206 compares the percentage of purchased items in the category that corresponds to the brand of interest to a number of thresholds to identify the loyalty level of the household to the brand of interest. For example, the threshold percent for the loyal level may be 80%, the threshold range for the switcher level may be between 20% and 79%, the threshold range for the non-loyal level may be between 19% and 0%, and the non-brand label may be 0%. In such an example, if the household purchased 100 soda dollars, units or volume within a year and 95 of the dollars, units, or volume corresponds to COKE® products, the threshold comparator 206 would compare the 95% COKE® purchases to the above-thresholds and the loyalty analyzer 204 would label that household as at the loyal level (e.g., because 95% is greater than the 90% loyal threshold).

The example loyalty comparator 208 of FIG. 2 (e.g., also referred to as loyalty comparator circuitry) compares the loyalty of households from a first duration of time to a second duration of time to identify changes in loyalty to a brand of interest (e.g., on an individual household level and/or on an aggregate level). For example, if during the first duration of time the loyalty analyzer 204 determined that a household was at the loyal level (e.g., level 5) and during a second duration of time the loyalty analyzer 204 determined that the household was at the non-loyal level (e.g. level 3), the loyalty comparator 208 determines that the loyalty of the household decreased by 2 steps (e.g., 3−5=−2, corresponding to a 2 step decrease in loyalty), using the example calculation circuitry 210. The example calculation circuitry 210 of the loyalty comparator 208 calculates the churn per household, the average absolute steps per household, and/or the net brand churn per household based on the loyalty data of households (e.g., all households or one or more subgroups of households, where a subgroup may correspond to households exposed to an advertisement or media, households that performed an action in response to exposure to an advertisement or media, one or more demographics of the households, locations of the households, etc.) between the two durations based on the household data between the two periods. The churn per household is the average number of steps moved up or down along the loyalty hierarchy per household. The average absolute steps per household is the absolute (e.g., absolute value of the different between loyalty levels) average steps moved up or down along the hierarchy per household. The net brand churn per household is the average steps up or down impacting brand only based on the households. To determine steps that impact brand only, the hierarchy level of non-brand and non-category are set to the same level (e.g., level 2).

Additionally, the example calculation circuitry 210 of FIG. 2 may calculate various other metrics related to churn and/or retention to be included in a report and/or as information for mitigation. For example, the calculation circuitry 210 may determine a retention of consumers based on a ratio of the number of retained consumers in a first (e.g., current) period of time and a number of brand consumers in a second (e.g., prior) period of time. The example calculation circuitry 210 may determine churn data based on a difference between one and a ratio of the number of retained consumers in a first period of time and a number of (a) brand consumers in the first period of time and (b) brand consumers in a second period of time. The example calculation circuitry 210 may determine net retention data based on a ratio of (a) the retained consumers in a first period of time and (b) a sum of the number of brand consumers in the first period of time and the number of brand consumers in the second period of time. The example calculation circuitry 210 may additionally determine churned consumers per retained consumers based on a ratio of (a) a sum of new consumers (as referred to as acquired consumers) and lost consumers and (b) a number of retained consumers. A new or acquired consumer is a consumer labelled as a non-brand consumer in a prior period and a brand consumer in a current period. A lost consumer is a consumer labelled as a brand consumer in a prior period and a non-brand consumer in a current period.

The example calculation circuitry 210 of FIG. 2 may additionally determine potential consumers per a difference between current consumers and “1” (or 100% or a total number of consumers) based on a difference between (i) a ratio of (a) a sum of a number of the retained consumers, a number of lost consumers, and a number of new consumers and (b) a number of brand consumers) and (ii) one. The example calculation circuitry 210 of FIG. 2 may additionally determine a ratio of lost and new consumers per current consumers based on a ratio of (a) the sum of a number of lost consumers and a number of new consumers and (b) a number of brand consumers. The example calculation circuitry 210 may additionally determine a ratio of current consumers to potential consumers based on a ratio of (a) a number of brand consumers and (b) a sum of a number of brand consumers, a number of retained consumers, and a number of lost consumers. The example calculation circuitry 210 may additionally determine acquisition data based on a ratio of a number of new brand consumers and an average number of brand consumers at the first and second periods. The example calculation circuitry 210 may additionally determine attrition data based on a ratio of a number of lost brand consumers and an average number of brand consumers at the first and second periods. The example calculation circuitry 210 may additionally determine net attrition data based on a ratio of (a) a difference of a number of new brand consumers and a number of new non-brand consumers and (b) an average number of brand consumers at the first and second periods. Additionally, the example calculation circuitry 210 may determine a number of lapsed consumers based on a number of consumers who (a) consumed or purchased a brand in a first current time period, (b) did not consume or purchase the brand during a second previous time period, and (c) consumed or purchased the brand during a third previous time period prior to the second previous time period.

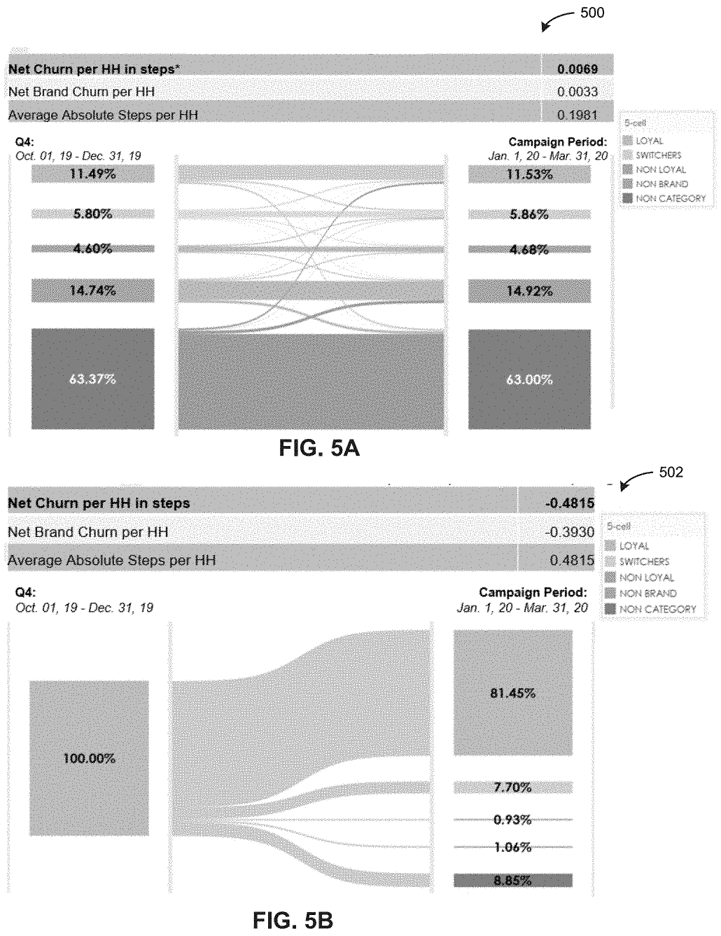

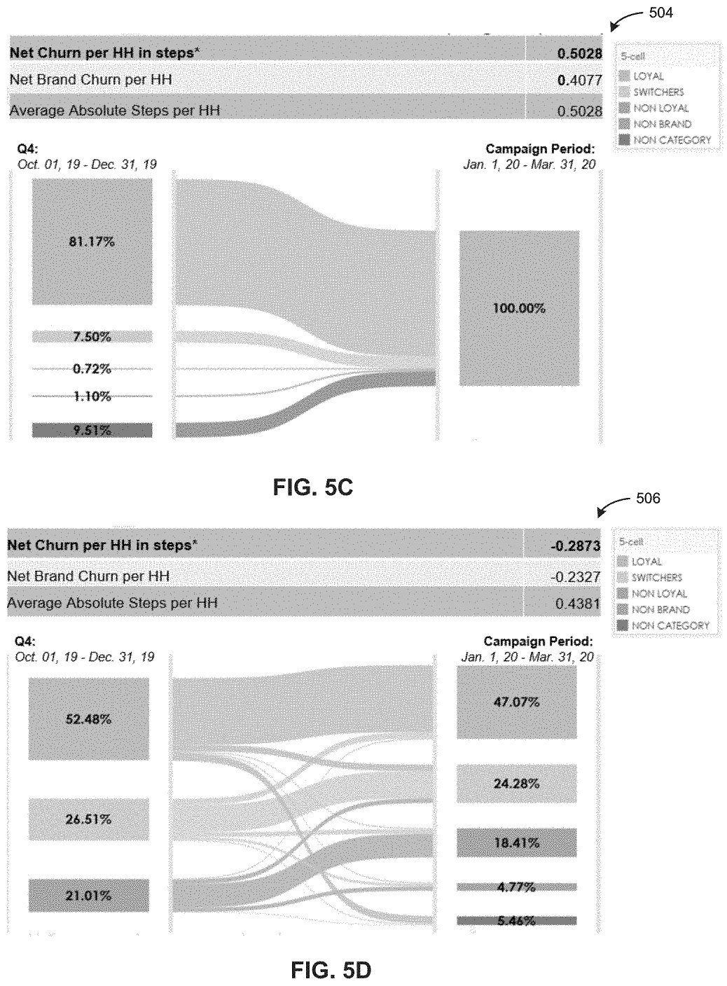

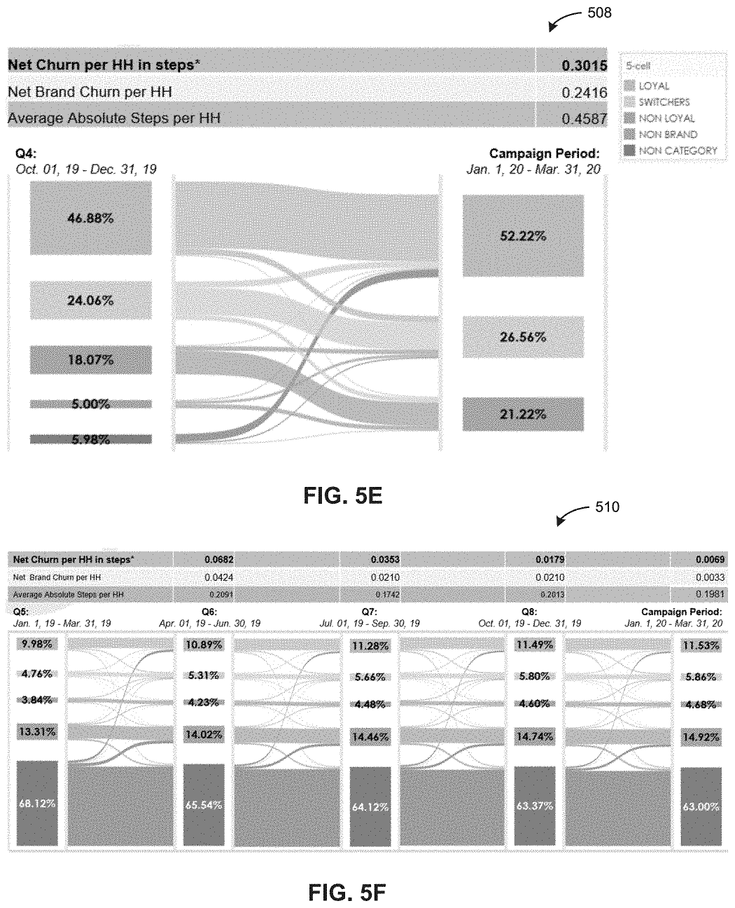

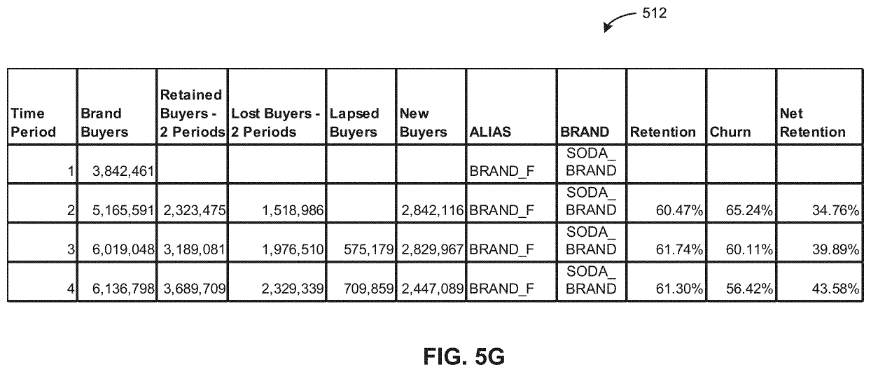

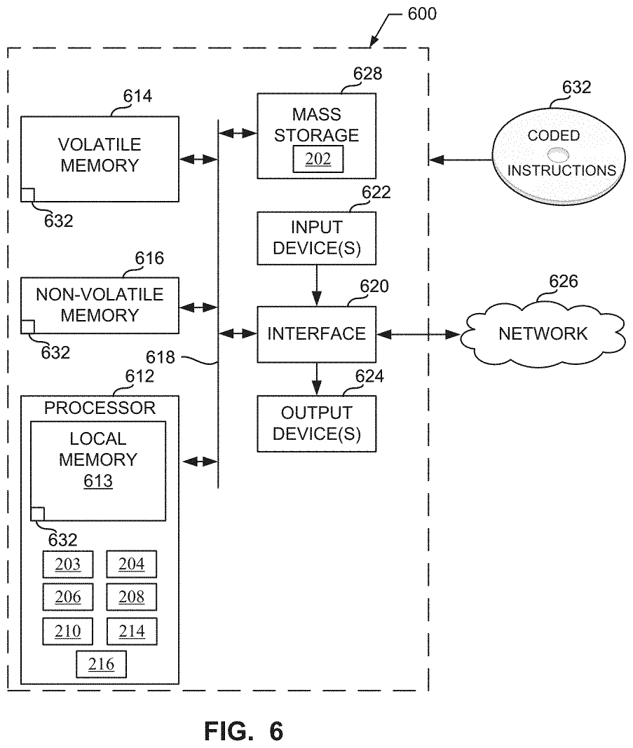

The example reporter 214 of FIG. 2 generates a report based on the loyalty information. For example, the reporter 214 may generate a report that includes a graph (e.g., a Sankey Diagram, a purchase graph, etc.) or other visual and/or data representation of the loyalty change from a first time period to a second time period for the households and/or a universe of households (e.g., based on the households), a subgroup of the households and/or weighted households (e.g., that corresponds to a location and/or one or more demographics), etc. Additionally, the example reporter 214 may include data identifying the churn per household, the average absolute steps per household, the net brand churn per household, retention data, net retention data, churned consumers per retained consumers data, potential consumers per current consumers data, lost and new consumers per current consumers data, current consumers per all potential consumers data, acquisition data, attrition data, net acquisition data, data related to acquired consumers, data related to lost consumers, etc. The report may be a visual report (e.g., to be output on a user interface or printed on paper) and/or may be a data signal that may be used by another device (e.g., the example advertisement mitigator 216) in order to take actions based on the results in the report. In some examples, the reporter 214 includes reports that are based on location, demographics, etc. In some examples, the reporter 214 may flag particular patterns identified based on the comparison. For example, when a brand changes an advertising campaign in an attempt to target new customers (e.g., increase one or more steps of the loyalty ladder), the brand may want to ensure that the number of customers gained does not cause loyalty to decrease amongst loyal customers (e.g., the leaky bucket problem). In such examples, the reporter 214 may flag or highlight if the number of households or weighted households that step up into a loyalty level from a first duration to a second duration is less than the number of household or weighted households that step down from the loyalty level, thereby indicating that the new advertisement campaign may be harming loyalty more than it is helping loyalty. The flag may be a value or string in association with a condition. The flag may be a value that is stored in storage and/or included in a report and/or data structure in association with particular events (e.g., particular patterns, a threshold number of households changing loyalty level, etc.). In some examples, the consumer-product analysis circuitry 106 includes an interface (e.g., the interface 620 of FIG. 6) that can transmit the report to a device and/or a customer via a wired or wireless communication. Examples of reports are further described below in conjunction with FIGS. 5A-5G.

The example advertisement mitigator 216 of FIG. 2 (e.g., also referred to as advertisement mitigation circuitry) adjusts advertisement campaign techniques based on the report. For example, if the report flags and/or otherwise indicates that a new advertisement campaign resulted in lowering loyalty rather than increasing loyalty, the advertisement mitigator 216 may adjust the campaign to change to another campaign (e.g., reverting back to a previous campaign). In another example, if the new advertisement campaign results in an increase in loyalty in first regions and/or in first demographics but a decrease in loyalty in second regions and/or in second demographics, the advertisement mitigator 216 may keep the new advertisement campaign in the first regions and/or for the first demographics and use a different campaign in the second regions and/or second demographics. Additionally or alternatively, the example advertisement mitigator 216 may target other regions similar to the first regions (e.g., by demographic, location, etc.) and/consumers corresponding to the first demographics using the new advertisement campaign and may target regions similar to the second reaction and/or consumers corresponding to the second demographics using a different advertisement campaign. In some examples, the advertisement mitigator 216 may adjust the budget and/or amount of advertisement for a brand based on the results.

While an example manner of implementing the consumer-product analysis circuitry 106 is illustrated in FIG. 2, one or more of the elements, processes and/or devices illustrated in FIG. 2 may be combined, divided, re-arranged, omitted, eliminated and/or implemented in any other way. Further, the example multiplier 203, the example loyalty analyzer 204, the example threshold comparator 206, the example loyalty comparator 208, the example calculation circuitry 210, the example reporter 214, the example advertisement mitigator 216 and/or, more generally, the example consumer-product analysis circuitry 106 of FIG. 2 may be implemented by hardware alone or by hardware in combination with software and/or firmware. Thus, for example, any of the example multiplier 203, the example loyalty analyzer 204, the example threshold comparator 206, the example loyalty comparator 208, the example calculation circuitry 210, the example reporter 214, the example advertisement mitigator 216 and/or, more generally, the example consumer-product analysis circuitry 106 of FIG. 2 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). Further still, the example consumer-product analysis circuitry 106 of FIG. 2 may include one or more elements, processes and/or devices in addition to, or instead of, those illustrated in FIG. 2, and/or may include more than one of any or all of the illustrated elements, processes, and devices.

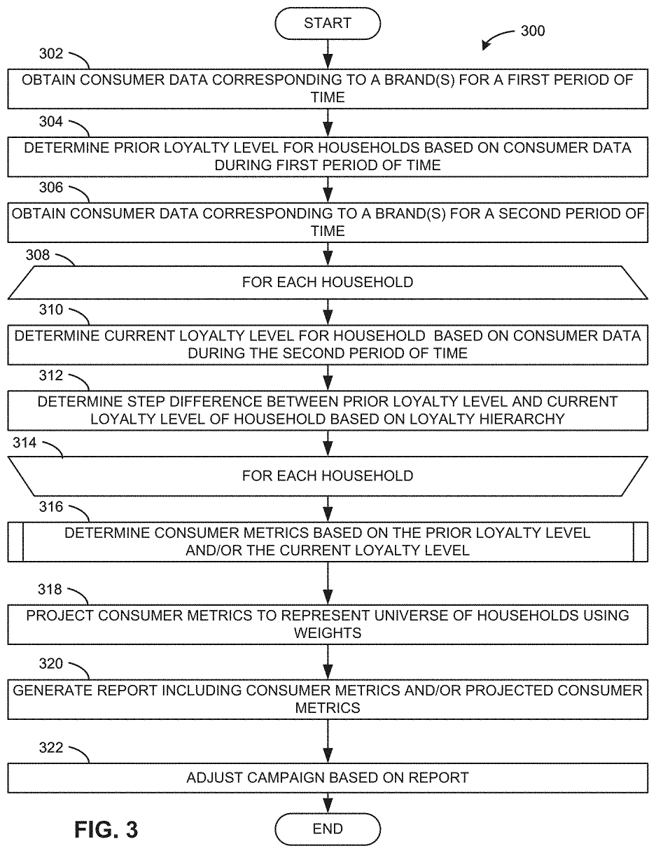

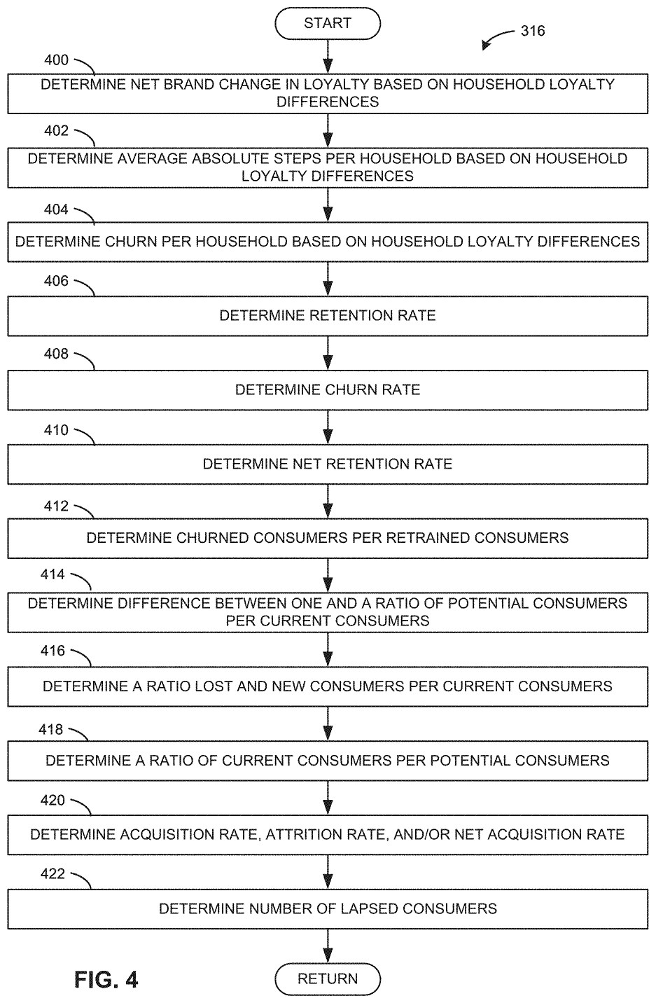

A flowchart representative of example hardware logic, machine readable instructions, hardware implemented state machines, and/or any combination thereof for implementing the consumer-product analysis circuitry 106 of FIG. 2 is shown in FIGS. 3 and 4. The machine readable instructions may be one or more executable programs or portion(s) of an executable program for execution by a computer processor and/or processor circuitry, such as the processor 612 shown in the example processor platform 600 discussed below in connection with FIG. 6. The program(s) may be embodied in software stored on a non-transitory computer readable storage medium such as a CD-ROM, a floppy disk, a hard drive, a solid-state driver (SSD), a DVD, a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 3 and 4, many other methods of implementing the example consumer-product analysis circuitry 106 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 3 and 4 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 3 illustrates an example flowchart representative of example machine readable instructions 300 that may be executed by the example consumer-product analysis circuitry 106 of FIG. 2 to monitor brand loyalty. Although the flowchart of FIG. 3 is described in conjunction with the example consumer-product analysis circuitry 106 of FIG. 2, the instructions may be executed by any computer. Additionally, although the flowchart is described in conjunction with household purchases, the flowchart may be used in conjunction with a person, group of people, etc. and/or may be based on brand exposure, store visits, website visits, etc.

At block 302, the example loyalty analyzer 204 (FIG. 2) obtains consumer data corresponding to one or more brands for a first period of time from the consumer data storage 202 (FIG. 2). As described above, the consumer data corresponds to items purchased by a consumer, group of consumers, and/or household with a timestamp of the purchases. At block 304, the example loyalty analyzer 204 determines the prior loyalty level for households based on consumer data corresponding to the households during the first period of time. As described above, the example loyalty analyzer 204 can analyze the consumer data within the first period of time to determine the percentage of time that the household purchased a product corresponding to a brand of interest as opposed to another brand in the same category of items. After the percentage is determined, the example threshold comparator 206 (FIG. 2) compares the percentage to thresholds that correspond to the different loyalty levels of the loyalty hierarchy (e.g., loyal=5, switches=4, non-loyal=3, non-brand=2, non-category=1).

At block 306, the example loyalty analyzer 204 obtains the consumer data corresponding to one or more brand(s) for a second period of time (e.g., a period of time after the first period of time) from the consumer data storage 202. For each household corresponding to the consumer data at the second period of time (blocks 308-314), the example loyalty analyzer 204 determines the current loyalty level for the corresponding household based on consumer data of the household during the second period of time (block 310).

At block 312, the example loyalty comparator 208 (FIG. 2) determines a step difference between the prior loyalty level (e.g., determined during the first time period) and the current loyalty level (e.g., determined during the second time period) of the household based on the loyalty hierarchy. For example, if the loyalty analyzer 204 labelled the household as a switcher (e.g., level 4) at the first duration of time and labelled the household as loyal (e.g., level 5) at the second duration of time, the example calculation circuitry 210 (FIG. 2) of the example loyalty comparator 208 determines the difference in loyalty to be 1 (e.g., 5−4=1 corresponding to a 1 step increase in loyalty). If the loyalty remains the same between the two periods of time, the difference is zero (e.g., 5−5=0). At block 316, the example consumer-product analysis circuitry 106 determines consumer metrics based on the prior loyalty level and/or the current loyalty level. For example, the consumer-product analysis circuitry 106 may determine consumer metrics based on the consumer data and/or determined loyalty level/step differences, as further described below in conjunction with FIG. 4.

At block 318, the example multiplier 203 (FIG. 2) projects the consumer metrics to represent a universe of household using weights. As described above, the example multiplier 203 weights the households (or individual consumers, groups of consumers, etc.) so that the consumer data stored in the example consumer data storage 202 represents a universe of consumers, universe of households, etc. Because the household data and/or the universe may have changed between the first period of time and the second period of time, the weights for household for the first period of time may be different than the weights for the households for the second duration of time. At block 320, the example reporter 214 (FIG. 2) generates a report including consumer metrics and/or projected consumer metrics. The consumer metrics and/or projected consumer metrics may include a comparison of priority loyalty to currently loyalty across the weighted and/or projected households (e.g., which represent a universe of households corresponding to a city, a state, a nation, etc.), the net brand change in loyalty, the average absolute steps per household and/or the churn per household. In some examples, the reporter 214 can use the household counts and/or value to project (and report) a final dollar value or unit value to a national number. Example reports are further described below in conjunction with FIGS. 5A-5G. In some examples, an interface transmits the report to another device via a wired or wireless communication. At block 322, the example advertisement mitigator 216 (FIG. 2) adjust the advertising campaign based on the report, as further described above in conjunction with FIG. 2.

FIG. 4 illustrates an example flowchart representative of example machine readable instructions 316 that may be executed by the example consumer-product analysis circuitry 106 of FIG. 2 to determine consumer metrics based on purchase, consumer, and/or consumption data, as further described above in conjunction with block 316 of FIG. 3. Although the flowchart of FIG. 4 is described in conjunction with the example consumer-product analysis circuitry 106 of FIG. 2, the instructions may be executed by any computer. Additionally, although the flowchart is described in conjunction with household purchases, the flowchart may be described in conjunction with a person, group of people, etc. and/or may be based on brand exposure, store visits, website visits, etc.

At block 400, the example loyalty comparator 208 (FIG. 2) determines the net brand change in loyalty based on household loyalty differences. For example, the calculation circuitry 210 (FIG. 2) calculates an average step up or down impacting brand loyalty across the households (e.g., where the non-loyal level and the non-category level are at the same level). At block 402, the example loyalty comparator 208 determines the average absolute steps per household based on the household loyalties differences. For example, the loyalty comparator 208 takes the absolute value of the steps travelled up or down to keep the step changes to a positive value and the example calculation circuitry 210 calculates an average of the absolute average steps traveled up or down the hierarchy per household. At block 404, the example loyalty comparator 208 determines the churn per household based on the household loyalty differences across the households. For example, the loyalty comparator 208 averages the steps up (e.g., positive differences) or down (e.g., negative differences) the loyalty hierarchy per household. In some examples, the chum per household can be used to subset the data. For example, the churn may be used to subset only loyal consumers in the first period of time, only loyal consumers in the second period of time, or loyal consumers in both the first and the second periods of time. In some examples, chum may be used to analyze only consumers who went up or down X number of steps, where X can be defined as any value that a customer is interested in.

At block 406, the example calculation circuitry 210 determines a retention data of consumers. For example, the calculation circuitry 210 may determine the retention data based on a ratio of the number of retained consumers in a first (e.g., current) period of time and a number of brand consumers in a second (e.g., prior) period of time. At block 408, the example calculation determines the churn data of consumers. For example, the calculation circuitry 210 may determine the churn data based on a difference between one and a ratio of the number of retained consumers in a first period of time and a number of (a) brand consumers in the first period of time and (b) brand consumers in a second period of time. At block 410, the example calculation circuitry 210 determines a net retention data. The calculation circuitry 210 may determine the net retention data based on a ratio of (a) the retained consumers in a first period of time and (b) a sum of the number of brand consumers in the first period of time and the number of brand consumers in the second period of time.

At block 412, the example calculation circuitry 210 determines a ratio of churned consumers per retrained consumers. The example calculation circuitry 210 may determine the churned consumers per retained consumers based on a ratio of (a) a sum of new consumers (as referred to as acquired consumers) and lost consumers and (b) a number of retained consumers. A new or acquired consumer is a consumer labelled as a non-brand consumer in a prior period and a brand consumer in a current period. A lost consumer is a consumer labelled as a brand consumer in a prior period and a non-brand consumer in a current period. At block 414, the example calculation circuitry 210 determines a difference between one and a ratio of potential consumers per current consumers. For example, the calculation circuitry 210 of FIG. 2 may determine the potential consumers per a difference between current consumers and “1” (or 100% or a total number of consumers) based on a difference between (i) a ratio of (a) a sum of a number of the retained consumers, a number of lost consumers, and a number of new consumers and (b) a number of brand consumers) and (ii) one.

At block 416, the example calculation circuitry 210 determines a ratio of lost and new consumers per current consumers. For example, the example calculation circuitry 210 of FIG. 2 may determine the ratio of lost and new consumers per current consumers based on a ratio of (a) the sum of a number of lost consumers and a number of new consumers and (b) a number of brand consumers. At block 418, the example calculation circuitry 210 determines a ratio of current consumers per potential consumers. For example, the calculation circuitry 210 may determine the ratio of current consumers to potential consumers based on a ratio of (a) a number of brand consumers and (b) a sum of a number of brand consumers, a number of retained consumers, and a number of lost consumers.

At block 420, the example calculation circuitry 210 determines acquisition data, attrition data, and/or net acquisition data. For example, the example calculation circuitry 210 may determine the acquisition data based on a ratio of a number of new brand consumers and an average number of brand consumers at the first and second periods. The example calculation circuitry 210 may determine the attrition data based on a ratio of a number of lost brand consumers and an average number of brand consumers at the first and second periods. The example calculation circuitry 210 may determine the net attrition data based on a ratio of (a) a difference of a number of new brand consumers and a number of new non-brand consumers and (b) an average number of brand consumers at the first and second periods. At block 422, the example calculation circuitry 210 determines a number of lapsed consumers. For example, the example calculation circuitry 210 may determine the number of lapsed consumers based on a number of consumers who (a) consumed or purchased a brand in a first current time period, (b) did not consume or purchase the brand during a second previous time period, and (c) consumed or purchased the brand during a third previous time period prior to the second previous time period. After block 422, control returns to block 318 of FIG. 3.

FIGS. 5A-5G illustrate different reports or parts of a report that may be generated by the consumer-product analysis circuitry 106. Although FIGS. 5A-5G illustrate examples of reports, additional and/or other reports or information may be included in a report. For example, although the reports of FIGS. 5A-5G correspond to a universe of consumers, the reports may correspond to a universe of consumers in a particular location, a universe of consumers that correspond to particular demographics, etc.

FIG. 5A illustrates an example report 500 showing changes in loyalty from a first period of time (Q4) to a second period of time (campaign period). The example report 500 of FIG. 5A includes the net churn per household in steps, the net brand churn per household, an average absolute steps per household and a Sankey diagram illustrating changes in loyalty across the households. Although a Sankey diagram is shown, the report may include any manner of representing change in loyalty between the two or more periods of time. FIG. 5B includes an example report 502 that focusses on the loyalty of loyal consumers (e.g., buyers) of a brand in a first period to a second period. FIG. 5B illustrates that from the first period to the second period 81.45% of loyal households remained loyal, 7.7% moved from loyal to switcher, 0.93% moved from loyal to non-loyal, 1.06% moved from loyal to non-brand, and 8.85% moved from loyal to non-category. Because the focus is on the top level of the hierarchy all the net measures are negative.

FIG. 5C illustrates an example report 504 that includes data related to where the loyal customers of the campaign period came from. For example, 81.17% of the loyal households came from loyal households in the previous period, 7.5% of the loyal households came from the switcher households in the previous period, etc. FIG. 5D illustrates an example report 506 including the level changes of brand consumers (e.g., loyal, switcher, or non-loyal) from Q4 to the campaign period. FIG. 5E illustrates an example report 508 which includes levels the brand consumers in the campaign period are coming from in Q4. FIG. 5F illustrates an example graph 510 including loyalty changes across weighted household over five time periods, although any number of time periods may be included in the report.

FIG. 5G illustrates an example report 512 that includes various other consumer metrics. The example report 512 corresponds to purchase information related to a particular location with respect to a particular Soda brand. The example report 512 corresponds to four time periods, although any number of time periods may be used. The example report 512 includes data related to the number of brand buyers for the particular soda brand at the different time periods, the number of retained buyers between two periods of time, the number of lost buyers between two periods of time, the number of lapsed buyers, the number of new buyers, an alias for the brand, retention data, churn data, and net retention data. The data related to brand buys corresponds to the number of buyers who purchased the brand in the corresponding time period. The data related to retained buyers corresponds to a number of buyers who purchased the brand in a particular time period and a time period prior to the particular time period. The data related to the lost buyers corresponds to a number of buyers who did not purchase the brand in a particular time period, but purchased the brand in a time period prior to the particular time period. The data related to lapsed buyers corresponds to a number of buyers who purchased the brand in a particular time period, did not purchase in the time period prior to the particular time period, but did purchase in two time periods prior to the particular time period. The data related to the new buyers corresponds to a number of buyers who purchased the brand in a particular time period, but did not purchase the brand in the time period prior to the particular time period. The retention, chum, and net retention correspond to the definitions described above.

FIG. 6 is a block diagram of an example processor platform 600 structured to execute the instructions 300 of FIG. 3 to implement the consumer-product analysis circuitry 106 of FIG. 2. The processor platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a set top box, or any other type of computing device.

The processor platform 600 of the illustrated example includes a processor 612. The processor 612 of the illustrated example is hardware. For example, the processor 612 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example multiplier 203, the example loyalty analyzer 204, the example threshold comparator 206, the example loyalty comparator 208, the example calculation circuitry 210, the example calculation circuitry 210, the example reporter 214, and the example advertisement mitigator 216.

The processor 612 of the illustrated example includes a local memory 613 (e.g., a cache). The processor 612 of the illustrated example is in communication with a main memory including a volatile memory 614 and a non-volatile memory 616 via a bus 618. The volatile memory 614 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 616 may be implemented by flash memory and/or any other desired type of memory device. Access to the main memory 614, 616 is controlled by a memory controller.

The processor platform 600 of the illustrated example also includes an interface circuit 620. The interface circuit 620 may be implemented by any type of interface standard, such as an Ethernet interface, a universal serial bus (USB), a Bluetooth® interface, a near field communication (NFC) interface, and/or a PCI express interface.

In the illustrated example, one or more input devices 622 are connected to the interface circuit 620. The input device(s) 622 permit(s) a user to enter data and/or commands into the processor 612. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 624 are also connected to the interface circuit 620 of the illustrated example. The output devices 624 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 620 of the illustrated example, thus, typically includes a graphics driver card, a graphics driver chip and/or a graphics driver processor.

The interface circuit 620 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 626. The communication can be via, for example, an Ethernet connection, a digital subscriber line (DSL) connection, a telephone line connection, a coaxial cable system, a satellite system, a line-of-site wireless system, a cellular telephone system, etc.

The processor platform 600 of the illustrated example also includes one or more mass storage devices 628 for storing software and/or data. Examples of such mass storage devices 628 include floppy disk drives, hard drive disks, compact disk drives, Blu-ray disk drives, redundant array of independent disks (RAID) systems, and digital versatile disk (DVD) drives. In the example of FIG. 6 the mass storage devices 628 implements the example consumer data storage 202.

Example machine executable instructions 632 represented in FIGS. 3 and 4 may be stored in the mass storage device 628, in the volatile memory 614, in the non-volatile memory 616, and/or on a removable non-transitory computer readable storage medium such as a CD or DVD.

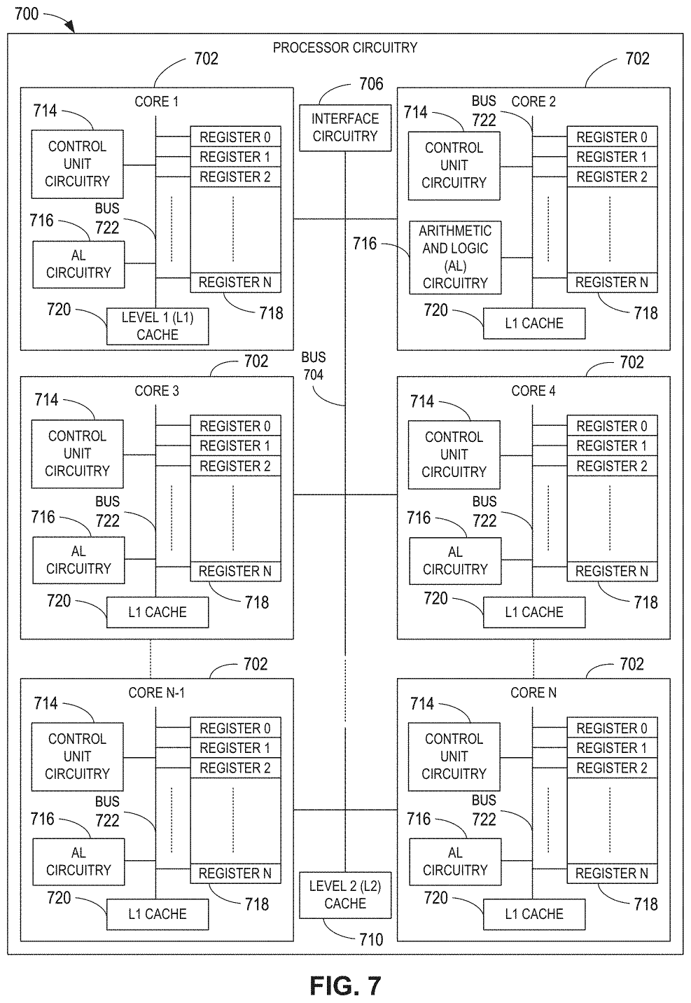

FIG. 7 is a block diagram of an example implementation of the processor circuitry 612 of FIG. 6. In this example, the processor circuitry 612 of FIG. 6 is implemented by a general purpose microprocessor 700. The general purpose microprocessor circuitry 700 executes some or all of the machine readable instructions of the flowcharts of FIGS. 3 and 4 to effectively instantiate the consumer-product analysis circuitry 106 of FIG. 2 as logic circuits to perform the operations corresponding to those machine readable instructions. In some such examples, the circuitry of FIG. 2 is instantiated by the hardware circuits of the microprocessor 700 in combination with the instructions. For example, the microprocessor 700 may implement multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowchart of FIGS. 3 and 4.

The cores 702 may communicate by a first example bus 704. In some examples, the first bus 704 may implement a communication bus to effectuate communication associated with one(s) of the cores 702. For example, the first bus 704 may implement at least one of an Inter-Integrated Circuit (I2C) bus, a Serial Peripheral Interface (SPI) bus, a PCI bus, or a PCIe bus. Additionally or alternatively, the first bus 704 may implement any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2_cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the L1 cache 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating point operations. In yet other examples, the AL circuitry 716 may include first AL circuitry that performs integer based operations and second AL circuitry that performs floating point operations. In some examples, the AL circuitry 716 may be referred to as an Arithmetic Logic Unit (ALU). The registers 718 are semiconductor-based structures to store data and/or instructions such as results of one or more of the operations performed by the AL circuitry 716 of the corresponding core 702. For example, the registers 718 may include vector register(s), SIMD register(s), general purpose register(s), flag register(s), segment register(s), machine specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure including distributed throughout the core 702 to shorten access time. The second bus 722 may implement at least one of an I2C bus, a SPI bus, a PCI bus, or a PCIe bus

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

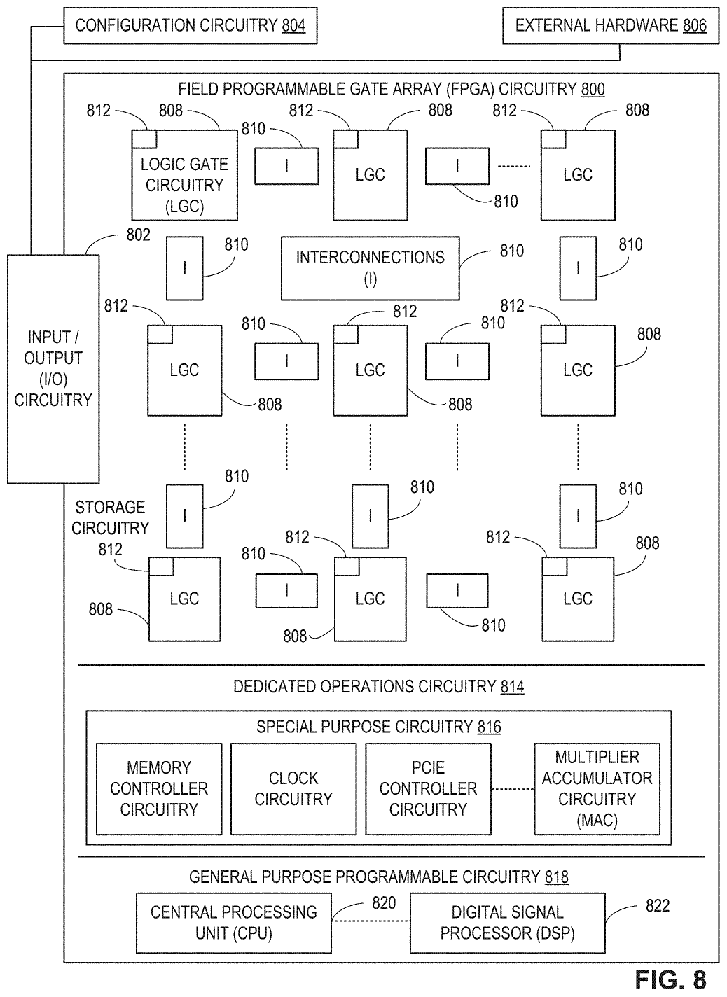

FIG. 8 is a block diagram of another example implementation of the processor circuitry 612 of FIG. 6. In this example, the processor circuitry 612 is implemented by FPGA circuitry 800. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the machine readable instructions in hardware and, thus, can often execute the operations faster than they could be performed by a general purpose microprocessor executing the corresponding software.

More specifically, in contrast to the microprocessor 700 of FIG. 7 described above (which is a general purpose device that may be programmed to execute some or all of the machine readable instructions represented by the flowcharts of FIGS. 3 and 4 but whose interconnections and logic circuitry are fixed once fabricated), the FPGA circuitry 800 of the example of FIG. 8 includes interconnections and logic circuitry that may be configured and/or interconnected in different ways after fabrication to instantiate, for example, some or all of the machine readable instructions represented by the flowcharts of FIGS. 3 and 4. In particular, the FPGA 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the software represented by the flowcharts of FIGS. 3 and 4. As such, the FPGA circuitry 800 may be structured to effectively instantiate some or all of the machine readable instructions of the flowcharts of FIGS. 3 and 4 as dedicated logic circuits to perform the operations corresponding to those software instructions in a dedicated manner analogous to an ASIC. Therefore, the FPGA circuitry 800 may perform the operations corresponding to the some or all of the machine readable instructions of FIGS. 3 and 4 faster than the general purpose microprocessor can execute the same.

In the example of FIG. 8, the FPGA circuitry 800 is structured to be programmed (and/or reprogrammed one or more times) by an end user by a hardware description language (HDL) such as Verilog. The FPGA circuitry 800 of FIG. 8, includes example input/output (I/O) circuitry 802 to obtain and/or output data to/from example configuration circuitry 804 and/or external hardware (e.g., external hardware circuitry) 806. For example, the configuration circuitry 804 may implement interface circuitry that may obtain machine readable instructions to configure the FPGA circuitry 800, or portion(s) thereof. In some such examples, the configuration circuitry 804 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 806 may implement the microprocessor 700 of FIG. 7. The FPGA circuitry 800 also includes an array of example logic gate circuitry 808, a plurality of example configurable interconnections 810, and example storage circuitry 812. The logic gate circuitry 808 and interconnections 810 are configurable to instantiate one or more operations that may correspond to at least some of the machine readable instructions of FIGS. 3 and 4 and/or other desired operations. The logic gate circuitry 808 shown in FIG. 8 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations. The logic gate circuitry 808 may include other electrical structures such as look-up tables (LUTs), registers (e.g., flip-flops or latches), multiplexers, etc.

The interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example Dedicated Operations Circuitry 814. In this example, the Dedicated Operations Circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the processor circuitry 612 of FIG. 6, many other approaches are contemplated. For example, as mentioned above, modern FPGA circuitry may include an on-board CPU, such as one or more of the example CPU 820 of FIG. 8. Therefore, the processor circuitry 612 of FIG. 6 may additionally be implemented by combining the example microprocessor 700 of FIG. 7 and the example FPGA circuitry 800 of FIG. 8. In some such hybrid examples, a first portion of the machine readable instructions represented by the flowcharts of FIGS. 3 and 4 may be executed by one or more of the cores 702 of FIG. 7, a second portion of the machine readable instructions represented by the flowcharts of FIGS. 3 and 4 may be executed by the FPGA circuitry 800 of FIG. 8, and/or a third portion of the machine readable instructions represented by the flowcharts of FIGS. 3 and 4 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 612 of FIG. 6 may be in one or more packages. For example, the processor circuitry 700 of FIG. 7 and/or the FPGA circuitry 800 of FIG. 8 may be in one or more packages. In some examples, an XPU may be implemented by the processor circuitry 612 of FIG. 6, which may be in one or more packages. For example, the XPU may include a CPU in one package, a DSP in another package, a GPU in yet another package, and an FPGA in still yet another package.

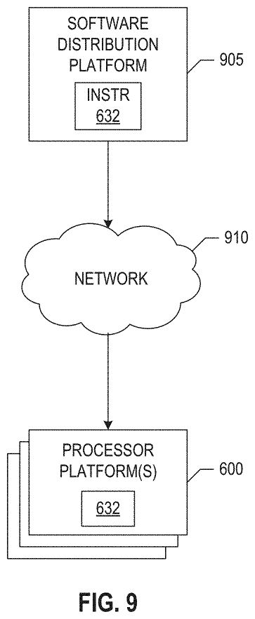

A block diagram illustrating an example software distribution platform 905 to distribute software such as the example machine readable instructions 632 of FIG. 6 to hardware devices owned and/or operated by third parties is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 632 of FIG. 9. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 632, which may correspond to the example machine readable instructions 300, 316 of FIGS. 3 and 4 as described above. The one or more servers of the example software distribution platform 905 are in communication with a network 910, which may correspond to any one or more of the Internet and/or any of the example network 102 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 632 from the software distribution platform 905. For example, the software, which may correspond to the example machine readable instructions 300, 316 of FIGS. 3 and 4. may be downloaded to the example processor platform 600, which is to execute the machine readable instructions 632 to implement the example consumer-product analysis circuitry 106. In some example, one or more servers of the software distribution platform 905 periodically offer, transmit, and/or force updates to the software (e.g., the example machine readable instructions 632 of FIG. 6) to ensure improvements, patches, updates, etc., are distributed and applied to the software at the end user devices.

Example methods, apparatus, systems, and articles of manufacture to monitor data records of logged consumer data are disclosed herein. Further examples and combinations thereof include the following: Example 1 includes an apparatus comprising processor circuitry including one or more of at least one of a central processing unit, a graphic processing unit, or a digital signal processor, the at least one of the central processing unit, the graphic processing unit, or the digital signal processor having control circuitry to control data movement within the processor circuitry, arithmetic and logic circuitry to perform one or more first operations corresponding to instructions, and one or more registers to store a result of the one or more first operations, the instructions in the apparatus, a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations, or Application Specific Integrate Circuitry (ASIC) including logic gate circuitry to perform one or more third operations, the processor circuitry to perform at least one of the first operations, the second operations, or the third operations to instantiate loyalty analyzation circuitry to determine a first level of loyalty to a brand for a household based on first data records of consumer data corresponding to a first period of time, and determine a second level of loyalty to the brand for the household based on second data records of consumer data corresponding to a second period of time after the first period of time, loyalty comparator circuitry to determine consumer metrics based on the first level of loyalty and the second level of loyalty, and report generation circuitry to generate a report based on the consumer metrics.

Example 2 includes the apparatus of example 1, wherein the consumer metrics include a churn data based on the first level of loyalty being different than the second level of loyalty.

Example 3 includes the apparatus of example 1, wherein the consumer metrics include retention data based on the first level of loyalty being the same as the second level of loyalty.

Example 4 includes the apparatus of example 1, wherein the consumer metrics include an acquisition data based on the first level of loyalty being lower than the second level of loyalty.

Example 5 includes the apparatus of example 1, wherein the consumer metrics include an attrition data based on the first level of loyalty being higher than the second level of loyalty.

Example 6 includes the apparatus of example 1, wherein the loyalty analyzation circuitry is to determine a third level of loyalty to the brand for the household based on third data records of consumer data corresponding to a third period of time after the second period of time, the consumer metrics including lapsed buyer information, the lapsed buyer information based on the first level of loyalty and the third level of loyalty being higher than the second level of loyalty.

Example 7 includes the apparatus of example 1, further including mitigator circuitry to adjust a campaign based on the report.

Example 8 includes the apparatus of example 1, wherein the report includes a Sankey diagram corresponding to the first period of time and the second period of time.

Example 9 includes a non-transitory computer readable medium comprising instructions which, when executed, cause one or more processor to at least determine a first level of loyalty to a brand for a household based on first data records of consumer data corresponding to a first period of time, and determine a second level of loyalty to the brand for the household based on second data records of consumer data corresponding to a second period of time after the first period of time, determine consumer metrics based on the first level of loyalty and the second level of loyalty, and generate a report based on the consumer metrics.

Example 10 includes the computer readable medium of example 9, wherein the consumer metrics include a churn data based on the first level of loyalty being different than the second level of loyalty.

Example 11 includes the computer readable medium of example 9, wherein the consumer metrics include retention data based on the first level of loyalty being the same as the second level of loyalty.

Example 12 includes the computer readable medium of example 9, wherein the consumer metrics include an acquisition data based on the first level of loyalty being lower than the second level of loyalty.

Example 13 includes the computer readable medium of example 9, wherein the consumer metrics include an attrition data based on the first level of loyalty being higher than the second level of loyalty.

Example 14 includes the computer readable medium of example 9, wherein the instructions cause the one or more processors to determine a third level of loyalty to the brand for the household based on third data records of consumer data corresponding to a third period of time after the second period of time, the consumer metrics including lapsed buyer information, the lapsed buyer information based on the first level of loyalty and the third level of loyalty being higher than the second level of loyalty.

Example 15 includes the computer readable medium of example 9, wherein the instructions cause the one or more processors to adjust a campaign based on the report.

Example 16 includes the computer readable medium of example 9, wherein the report includes a Sankey diagram corresponding to the first period of time and the second period of time.

Example 17 includes an apparatus comprising memory, instructions in the apparatus, and processor circuitry to execute the instructions to determine a first level of loyalty to a brand for a household based on first data records of consumer data corresponding to a first period of time, and determine a second level of loyalty to the brand for the household based on second data records of consumer data corresponding to a second period of time after the first period of time, determine consumer metrics based on the first level of loyalty and the second level of loyalty, and generate a report based on the consumer metrics.

Example 18 includes the apparatus of example 17, wherein the consumer metrics include a chum data based on the first level of loyalty being different than the second level of loyalty.

Example 19 includes the apparatus of example 17, wherein the consumer metrics include retention data based on the first level of loyalty being the same as the second level of loyalty.

Example 20 includes the apparatus of example 17, wherein the consumer metrics include an acquisition data based on the first level of loyalty being lower than the second level of loyalty.

From the foregoing, it will be appreciated that example methods, apparatus and articles of manufacture have been disclosed that monitor data records of logged consumer data. Although a traditional computer is able to collect consumer data related to brand loyalty, traditionally, a traditional computer has not been able to determine consumer metrics related to loyalty with respect to time to determine changes in loyalty and/or other time-based loyalty metrics. The disclosed methods, apparatus and articles of manufacture overcome the inability of a traditional computer by monitoring and/or tracking loyalty with respect to time to be able to mitigate negative changes in loyalty. The disclosed methods, apparatus and articles of manufacture are accordingly directed to one or more improvement(s) in the functioning of a computer by improving how a computer can more accurately analyze data records of logged consumer data to, for example, autonomously generate data records of logged consumer data.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An apparatus comprising:
processor circuitry including one or more of:
at least one of a central processing unit, a graphic processing unit, or a digital signal processor, the at least one of the central processing unit, the graphic processing unit, or the digital signal processor having control circuitry to control data movement within the processor circuitry, arithmetic and logic circuitry to perform one or more first operations corresponding to instructions, and one or more registers to store a result of the one or more first operations, the instructions in the apparatus;
a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations; or
Application Specific Integrate Circuitry (ASIC) including logic gate circuitry to perform one or more third operations;
the processor circuitry to perform at least one of the first operations, the second operations, or the third operations to instantiate:
loyalty analyzation circuitry to:
determine a first level of loyalty to a brand for a household based on first data records of consumer data corresponding to a first period of time; and
determine a second level of loyalty to the brand for the household based on second data records of consumer data corresponding to a second period of time after the first period of time;
loyalty comparator circuitry to determine consumer metrics based on the first level of loyalty and the second level of loyalty; and
report generation circuitry to generate a report based on the consumer metrics.

2. The apparatus of claim 1, wherein the consumer metrics include a churn data based on the first level of loyalty being different than the second level of loyalty.

3. The apparatus of claim 1, wherein the consumer metrics include retention data based on the first level of loyalty being the same as the second level of loyalty.

4. The apparatus of claim 1, wherein the consumer metrics include an acquisition data based on the first level of loyalty being lower than the second level of loyalty.

5. The apparatus of claim 1, wherein the consumer metrics include an attrition data based on the first level of loyalty being higher than the second level of loyalty.

6. The apparatus of claim 1, wherein the loyalty analyzation circuitry is to determine a third level of loyalty to the brand for the household based on third data records of consumer data corresponding to a third period of time after the second period of time, the consumer metrics including lapsed buyer information, the lapsed buyer information based on the first level of loyalty and the third level of loyalty being higher than the second level of loyalty.

7. The apparatus of claim 1, further including mitigator circuitry to adjust a campaign based on the report.

8. The apparatus of claim 1, wherein the report includes a Sankey diagram corresponding to the first period of time and the second period of time.

9. A non-transitory computer readable medium comprising instructions which, when executed, cause one or more processor to at least:
determine a first level of loyalty to a brand for a household based on first data records of consumer data corresponding to a first period of time; and
determine a second level of loyalty to the brand for the household based on second data records of consumer data corresponding to a second period of time after the first period of time;
determine consumer metrics based on the first level of loyalty and the second level of loyalty; and
generate a report based on the consumer metrics.

10. The computer readable medium of claim 9, wherein the consumer metrics include a churn data based on the first level of loyalty being different than the second level of loyalty.

11. The computer readable medium of claim 9, wherein the consumer metrics include retention data based on the first level of loyalty being the same as the second level of loyalty.

12. The computer readable medium of claim 9, wherein the consumer metrics include an acquisition data based on the first level of loyalty being lower than the second level of loyalty.

13. The computer readable medium of claim 9, wherein the consumer metrics include an attrition data based on the first level of loyalty being higher than the second level of loyalty.

14. The computer readable medium of claim 9, wherein the instructions cause the one or more processors to determine a third level of loyalty to the brand for the household based on third data records of consumer data corresponding to a third period of time after the second period of time, the consumer metrics including lapsed buyer information, the lapsed buyer information based on the first level of loyalty and the third level of loyalty being higher than the second level of loyalty.

15. The computer readable medium of claim 9, wherein the instructions cause the one or more processors to adjust a campaign based on the report.

16. The computer readable medium of claim 9, wherein the report includes a Sankey diagram corresponding to the first period of time and the second period of time.

17. An apparatus comprising:
memory;
instructions in the apparatus; and
processor circuitry to execute the instructions to:
determine a first level of loyalty to a brand for a household based on first data records of consumer data corresponding to a first period of time; and
determine a second level of loyalty to the brand for the household based on second data records of consumer data corresponding to a second period of time after the first period of time;
determine consumer metrics based on the first level of loyalty and the second level of loyalty; and
generate a report based on the consumer metrics.

18. The apparatus of claim 17, wherein the consumer metrics include a churn data based on the first level of loyalty being different than the second level of loyalty.

19. The apparatus of claim 17, wherein the consumer metrics include retention data based on the first level of loyalty being the same as the second level of loyalty.

20. The apparatus of claim 17, wherein the consumer metrics include an acquisition data based on the first level of loyalty being lower than the second level of loyalty.
